(19) United States
(12) Patent Application Publication
(10) Pub. No.: US 2026/0365451 A1
(43) Pub. Date: Nov. 19, 2026

(54) TRANSITION DEVICE AND PRODUCTION LINE

(71) Applicants: Fu Tai Hua Industry (Shenzhen) Co., Ltd., Shenzhen (CN); HON HAI PRECISION INDUSTRY CO., LTD., New Taipei (TW)

(72) Inventors: YEN-JUI YUN, NewTaipei (TW); CHEN-EN TSAI, NewTaipei (TW); CHIH-CHIANG KUO, NewTaipei (TW)

(21) Appl. No.: 19/254,446

(22) Filed: Jun. 30, 2025

(30) Foreign Application Priority Data
May 15, 2025 (CN) 202520964017.2

(51) Int. Cl. B65G 47/52; B65G 43/08; B65G 47/90

(52) U.S. Cl. CPC B65G 47/52; B65G 43/08; B65G 47/90; B65G 2201/0258; B65G 2203/0233; B65G 2203/044

(57) ABSTRACT

The present application discloses a transition device and a production line. The transition device includes a storage component designed to store trays, ensuring efficient handling. The conveying component consists of a first conveyor and a second conveyor, both positioned on one side of the storage component. The first conveyor is responsible for transporting trays loaded with materials, while the second conveyor moves empty trays in the opposite direction to facilitate reuse. Additionally, the transition device incorporates a transfer component that transfers trays between the storage component and the first conveyor, and between the storage component and the second conveyor. By storing or releasing trays as needed, the storage component mitigates the risk of blockages caused by excess trays or shortages due to insufficient tray supply, thereby enabling the system to adapt seamlessly to varying production speeds and maintain operational stability.

### FIELD

The disclosure herein generally relates to material transfer technology field, and more particularly relates to a transition device and a production line.

### BACKGROUND

In a production line, transition devices are typically used to transfer trays. The production line relies on trays to carry materials, and after processing, the transition device is needed to return the trays for reuse. However, the existing transition device cannot adapt to the varying production speeds of the production line for transferring and returning trays, leading to issues such as tray blockages or insufficient supply.

### BRIEF DESCRIPTION OF THE DRAWINGS

Many aspects of the disclosure can be better understood with reference to the following drawings. The components in the drawings are not necessarily drawn to scale, the emphasis instead being placed upon clearly illustrating the principles of the disclosure. Moreover, in the drawings, like reference numerals designate corresponding parts throughout the several views.

FIG. 1 is an isometric view of a production line provided by an embodiment of the present application.

FIG. 2 is an isometric view of a transition device shown in FIG. 1.

FIG. 3 is an isometric view of a conveying component shown in FIG. 2.

FIG. 4 is an isometric view of a storage component and a transfer component shown in FIG. 2.

FIG. 5 is an isometric view of the conveying component shown in FIG. 2.

FIG. 6 is an isometric view of another embodiment of the conveying component shown in FIG. 2.

FIG. 7 is an isometric view of another conveying component in FIG. 2.

FIG. 8 is an isometric view of another conveying component in FIG. 2.

FIG. 9 is an isometric view, from another perspective, of the conveying component in FIG. 8.

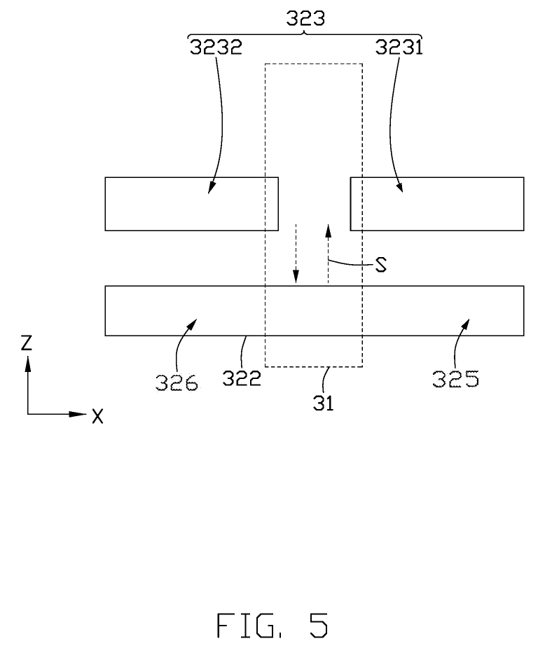

In FIGS. 5 to 8, “S” indicates a moving direction of the transition mechanism when storing or releasing trays.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, baffle structures, procedures, and components have not been described in detail so as not to obscure the related relevant feature being described. Also, the description is not to be considered as limiting the scope of the embodiments described herein. The drawings are not necessarily to scale and the proportions of certain parts have been exaggerated to better illustrate details and features of the present disclosure.

The present disclosure, including the accompanying drawings, is illustrated by way of examples and not by way of limitation. Several definitions that apply throughout this disclosure will now be presented. It should be noted that references to “an” or “one” embodiment in this disclosure are not necessarily to the same embodiment, and such references mean “at least one”.

The term “comprising” means “including, but not necessarily limited to;” it specifically indicates open-ended inclusion or membership in a so-described combination, group, series, and the like.

Without a given definition otherwise, all terms used have the same meaning as commonly understood by those skilled in the art. The terms used herein in the description of the present disclosure are for the purpose of describing specific embodiments only, and are not intended to limit the present disclosure.

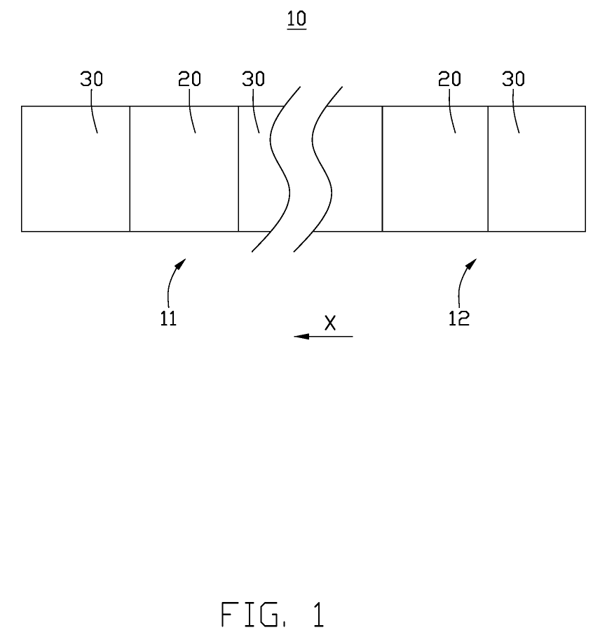

In some embodiments, as shown in FIG. 1, a production line 10 includes at least two processing devices 20 and at least one transition device 30. The production line 10 includes a head end 11 and a tail end 12 arranged oppositely. All processing devices 20 are sequentially arranged from the head end 11 to the tail end 12, with one processing device 20 located at the head end 11 and another at the tail end 12 (referred to as the processing device 20 at the head end 11 and the processing device 20 at the tail end 12, respectively). The transition device 30 is located between two adjacent processing devices 20. During operation, one processing device 20 processes materials on a tray (not shown in figures), and the transition device 30 transfers the tray to the next processing device 20, continuing in a cycle. This enables all processing devices 20 to process the materials sequentially, achieving automated processing of materials on the production line 10. After the processing device 20 at the tail end 12 completes processing, the materials are separated from the tray, and the tray is transported in reverse through the transition device 30 and processing device 20 to enable the tray to carry materials again.

In some embodiments, each processing device 20 includes a processing area (not shown in figures) and a conveyor line (not shown in figures) for conveying the tray, with at least one conveyor line passing through the processing area.

In some embodiments, two adjacent processing devices 20 are directly connected.

In some embodiments, the tray is part of the production line 10.

In some embodiments, all processing devices 20 are linearly arranged in a direction parallel to the direction in which the first conveyor conveys the trays.

In other embodiments, all processing devices 20 are arranged in a curved or polyline configuration along other directions.

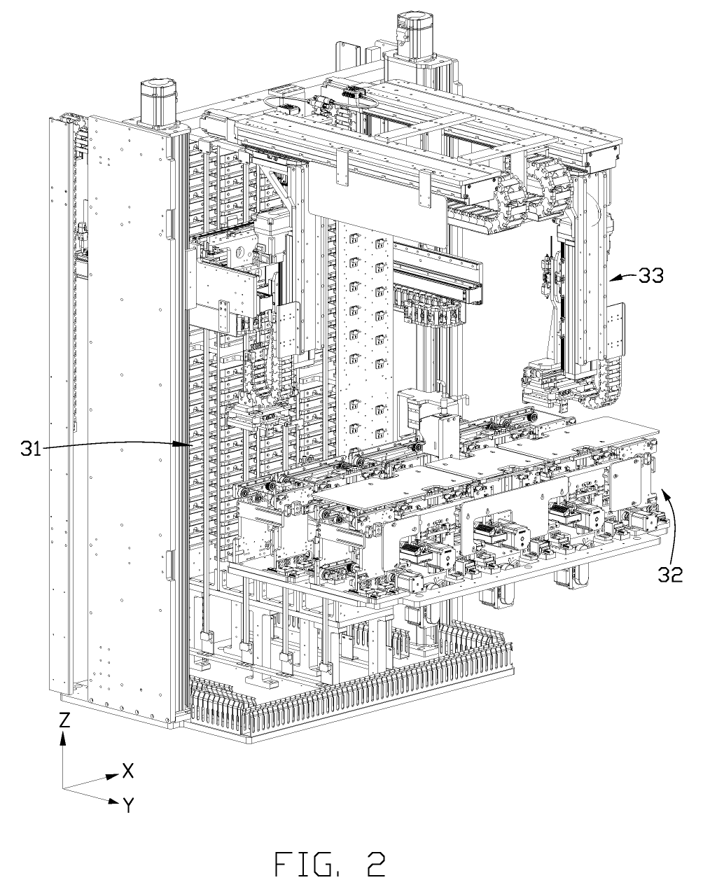

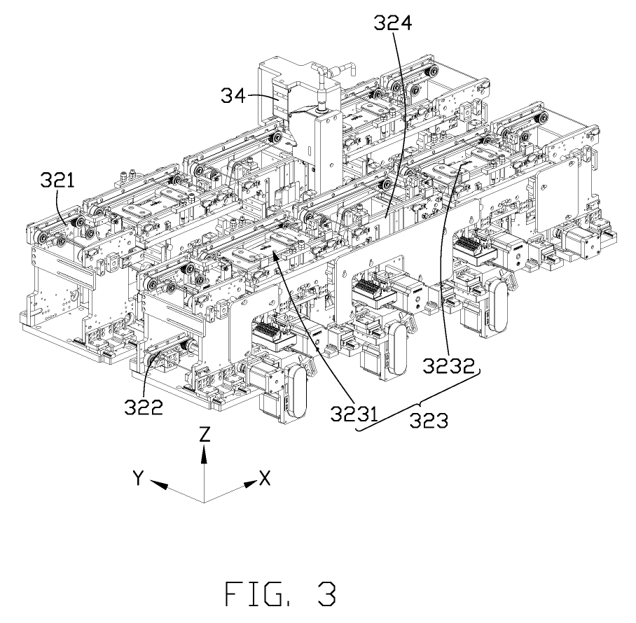

In some embodiments, as shown in FIGS. 2 and 3, the transition device 30 includes a conveying component 32, which includes a first conveyor 321 and a second conveyor 322. The first conveyor 321 is located on one side of the second conveyor 322 in a direction perpendicular to the direction in which the first conveyor conveys the trays. The first conveyor 321 of each transition device 30 connects to the conveyor line passing through the processing area of adjacent processing devices 20. The first conveyor 321 is used for conveying trays loaded with materials in the positive X direction, linking the conveyor lines of all processing devices 20 that pass through the processing areas (referred to as the transfer path). This enables all processing devices 20 to sequentially process materials on the trays. The second conveyor 322 of each transition device 30 connects to another conveyor line of adjacent processing devices 20 (referred to as the return path). The second conveyor 322 is used for conveying trays unloaded in opposite direction to the first conveyor, allowing the trays to move through all processing devices 20 to the head end 11 of the production line 10, where they can carry materials again, improving tray reuse efficiency.

In some embodiments, as shown in FIG. 2, the transition device 30 further includes a storage component 31 and a transfer component 33. The storage component 31 is located on one side of the first conveyor 321 and the second conveyor 322 in a direction perpendicular to the direction in which the first conveyor conveys the trays. The transfer component 33 is used for transferring trays between the first conveyor 321 and the storage component 31, and transferring trays between the second conveyor 322 and the storage component 31, enabling the storage component 31 to store trays from the first conveyor 321 and the second conveyor 322. When the processing device 20 operates at peak efficiency, the storage component 31 stores trays from the first conveyor 321 and the second conveyor 322 to reduce the risk of tray accumulation. When the processing device 20 operates at low efficiency, the storage component 31 releases trays to the first conveyor 321 and the second conveyor 322 to reduce the risk of insufficient tray supply.

For example, during the conveying of trays by the first conveyor 321 to the processing device 20, if the processing device 20 experiences low efficiency due to a malfunction or other factors, the transfer component 33 transfers trays from the first conveyor 321 to the storage component 31 for storage, reducing the risk of tray blockages on the first conveyor 321 due to excess trays. Once the processing device 20 resumes normal operation, the transfer component 33 releases trays from the storage component 31 to the first conveyor 321, allowing the first conveyor 321 to quickly convey trays to the processing device 20 (while potentially increasing the processing speed of the processing device 20). This accelerates material processing and tray output to downstream processing devices 20, reducing the risk of low production efficiency due to insufficient material supply downstream.

Similarly, during the conveying of trays by the second conveyor 322 to the processing device 20 at the head end 11, if one processing device 20 on the production line 10 experiences low efficiency due to a malfunction or other factors, the transfer component 33 transfers trays from the second conveyor 322 to the storage component 31 for storage, reducing the risk of tray accumulation on the second conveyor 322 causing blockages. Once the processing device 20 resumes normal operation, the transfer component 33 releases trays from the storage component 31 to the second conveyor 322, allowing the second conveyor 322 to quickly convey trays to the processing device 20 at the head end 11 (while potentially increasing the processing speed of the processing device 20). This accelerates material processing and tray output to downstream processing devices 20, reducing the risk of low production efficiency due to insufficient material supply downstream.

In some embodiments, when the number of processing devices 20 exceeds two, a transition device 30 is located between each pair of adjacent processing devices 20. This meets transfer demands while allowing each transition device 30 to store trays, reducing the risk of tray accumulation from the head end 11 to the tail end 12, which could lower the processing efficiency of multiple processing devices 20. Additionally, each transition device 30 releases trays, shortening the tray return distance from the tail end 12 to the head end 11. This reduces the tray supply time to the head end 11, enabling the processing device 20 at the head end 11 to process materials more quickly. The segmented storage and release of trays by multiple transition devices 30 mitigate the risk of tray quantity fluctuations during transfer or return, enhancing the overall processing efficiency stability of the production line 10.

In some embodiments, during operation, a carrier car (not explicitly shown) transfers materials from an external source to the processing device 20 at the head end 11 of the production line 10. A transition device 30 (referred to as the head end 11 transition device 30) is located before the processing device 20 at the head end 11 for transferring trays loaded with materials from the carrier car to the processing device 20 at the head end 11, enabling the input of materials to be processed into the production line 10.

After all processing devices 20 complete processing, materials are processed, a transition device 30 (referred to as the tail end 12 transition device 30) is located after the processing device 20 at the tail end 12 for transferring the trays loaded with materials to another carrier car (not explicitly shown), allowing the second carrier car to move the processed materials to the next production line or process. Meanwhile, the tail end 12 transition device 30 transfers trays unloaded from the second carrier car to the processing device 20 at the tail end 12, enabling trays unloaded to enter the production line 10 and move from the tail end to the head end 11. Finally, the head end 11 transition device 30 transfers empty trays from the processing device 20 at the head end 11 to the first carrier car, enabling the first carrier car to recycle empty trays to the previous production line.

In other embodiments, the carrier car or its exterior is equipped with a configuration to unload materials from trays or load materials onto trays. This allows the carrier car to transport only materials without moving trays to upstream or other production lines, accommodating trays to circulate within a single production line 10, achieving a one-to-one correspondence between trays and a production line.

In some embodiments, the carrier car is included in the production line 10.

In some embodiments, as shown in FIG. 3, the conveying component 32 further includes a transition mechanism 324. The transition mechanism 324 is used for providing trays from the first conveyor 321 to the transfer component 33, and providing trays from the second conveyor 322 to the transfer component 33. This enables the transfer component 33 to transfer trays outside the first conveyor 321 or second conveyor 322, reducing the risk of interference with other trays on the conveyor, preventing continuous tray conveyance interference. Additionally, it improves the efficiency of the transfer component 33 in transferring trays from the conveying component 32.

Furthermore, as shown in FIG. 3, the conveying component 32 further includes a supporting mechanism 323 located on one side of the first conveyor line 321 and the second conveyor 322. The supporting mechanism 323 includes a first area 3231 and a second area 3232 arranged oppositely. The transition mechanism 324 is used to carry or release trays at the first area 3231 or the second area 3232. The transfer component 33 is used to carry or release trays at the first area 3231 or the second area 3232. The provision of the first area 3231 and the second area 3232 enables the transfer component 33 and the transition mechanism 324 to carry or release trays at two locations. For example, after the transfer component 33 releases a tray in the first area 3231, it can carry a tray from the second area 3232. Similarly, after the transition mechanism 324 releases a tray in the second area 3232, it can carry a tray from the first area 3231. Compared to a single interaction location, this reduces the waiting time for the transfer component 33 or transition mechanism 324 to carry or release trays due to blockages or lack of trays, thereby improving the efficiency of tray transfer by the transfer component 33 and transition mechanism 324.

In some embodiments, as shown in FIG. 3, the transition mechanism 324 is located between the first area 3231 and the second area 3232, shortening the distance between the transition mechanism 324 and both areas, thus improving the working efficiency of the transition mechanism 324.

In some embodiments, the first area 3231 and the second area 3232 are arranged in a direction parallel or perpendicular to the direction in which the first conveyor 321 conveys trays. As shown in FIG. 3, for example, the first area 3231 and the second area 3232 are arranged along the X direction.

In other embodiments, the first area 3231 and the second area 3232 are arranged along the Y direction, with the X direction and Y direction being perpendicular to each other and both parallel to the horizontal plane.

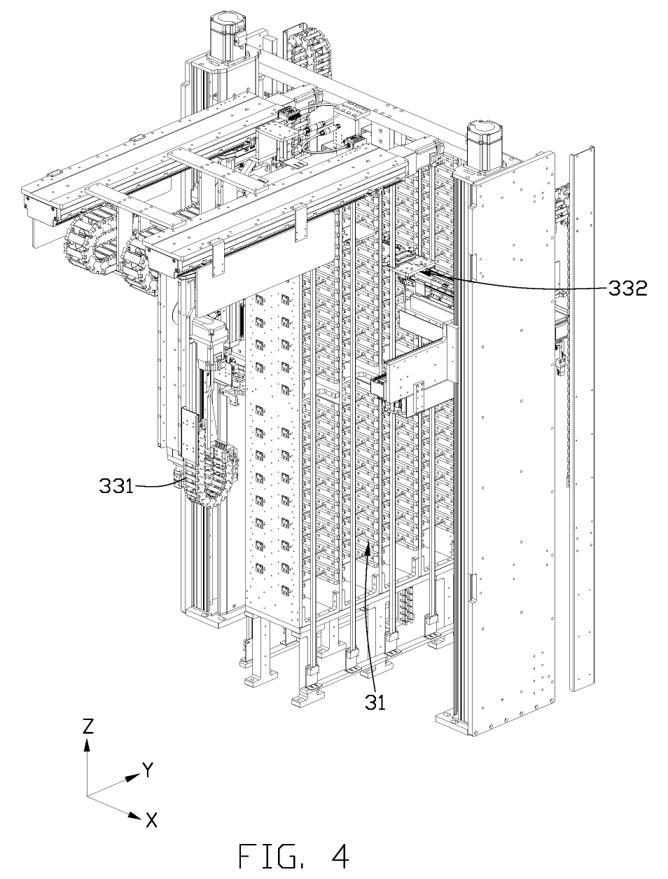

In some embodiments, as shown in FIGS. 2 and 4, in the direction in which the first area 3231 and the second area 3232 are arranged, the storage component 31 is located between the first area 3231 and the second area 3232, and both sides of the storage component 31 define openings used for allowing trays to pass through. Two transfer components 33 are provided: one transfer component 33 is used for transferring trays between the storage component 31 and the first area 3231, and the other transfer component 33 is used for transferring trays between the storage component 31 and the second area 3232.

For example, when the first area 3231 and the second area 3232 are arranged along the X direction, both sides of the storage component 31 define openings along the X direction. By locating the storage component 31 between the first area 3231 and the second area 3232, the distance from the storage component 31 to the first area 3231 and the second area 3232 is shortened, thereby improving the efficiency of the transfer components 33 in transferring trays. The openings on both sides enable bidirectional entry and exit of trays within the storage component 31, and the provision of two transfer components 33 enhances the efficiency of tray transfer by the storage component 31.

In some embodiments, as shown in FIG. 4, the storage component 31 defines a plurality of compartments for storing trays, with both sides of each compartment defining openings. The transfer component 33 includes a robot arm 331 and a feeding mechanism 332. The robot arm 331 is used for carrying trays from the first area 3231 or the second area 3232 to the feeding mechanism 332, which is movable into the compartment through the opening for storing trays in the compartment.

In some embodiments, the transition mechanism 324 is movable in a direction perpendicular to the direction in which the first conveyor conveys the trays, for carrying trays from the first conveyor 321 or releasing trays onto the first conveyor 321.

In some embodiments, the transition mechanism 324 is movable in a direction perpendicular to the direction in which the second conveyor conveys the trays, for carrying trays from the second conveyor 322 and the first conveyor 321 or releasing trays onto the second conveyor 322. For example, as shown in FIG. 5, the transition mechanism 324 is movable in a direction perpendicular to the X direction, passing over the second conveyor 322, and can carry trays from or release trays to the second conveyor 322. By moving the transition mechanism 324 in a direction perpendicular to the X direction, the travel distance of the transition mechanism 324 when passing over the first conveyor 321 and the second conveyor 322 is shortened. Additionally, compared to moving in an inclined direction, this reduces the risk of interference between the transition mechanism 324 and the first conveyor 321 or the second conveyor 322.

In some embodiments, as shown in FIG. 3, the first conveyor 321 and the supporting mechanism 323 are distributed in a direction perpendicular to the direction in which the first conveyor conveys the trays, with the supporting mechanism 323 located on the side of the second conveyor 322 in the positive Z direction (referred to as the first arrangement), where the negative Z direction is the direction of gravity, and the X, Y, and Z directions are mutually perpendicular. In other words, the supporting mechanism 323 is located above the second conveyor 322, resulting in the first conveyor 321, the supporting mechanism 323, and the second conveyor 322 forming an L-shaped distribution in a cross-section perpendicular to the horizontal plane, which helps make the structure of the conveying component 32 more compact. By locating the supporting mechanism 323 above the second conveyor 322 and on one side of the first conveyor 321 in the horizontal direction, the distance from the supporting mechanism 323 to the first conveyor 321 and the second conveyor 322 is shortened, improving the working efficiency of the transition mechanism 324. Additionally, since the conveyor lines within the processing device 20 correspond to the positional distribution of the first conveyor 321 and the second conveyor 322 in the transition device 30, locating the supporting mechanism 323 above the second conveyor 322, as opposed to above the first conveyor 321, allows clearance above the first conveyor 321. This enables the processing device 20 to directly process materials on the trays from the first conveyor 321 after receiving them, reducing the risk of the return conveyor line in the processing device 20 obstructing the processing area.

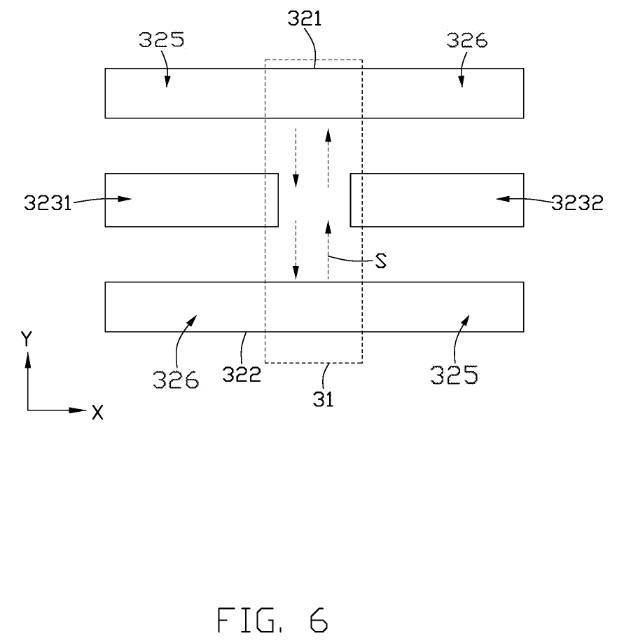

In other embodiments, as shown in FIG. 6, the first conveyor 321, the second conveyor 322, and the supporting mechanism 323 are distributed in a direction perpendicular to the direction in which the first conveyor conveys the trays. For example, the supporting mechanism 323 is located between the first conveyor 321 and the second conveyor 322 (referred to as the second arrangement). By arranging the first conveyor 321, the second conveyor 322, and the supporting mechanism 323 sequentially on the horizontal plane, the supporting mechanism 323 can carry trays from the first conveyor 321 and the second conveyor 322. Alternatively, in other embodiments, the second conveyor 322 is located between the first conveyor 321 and the supporting mechanism 323 (referred to as the third arrangement).

In some embodiments, the processing device 20 includes a processing device used for processing materials, located on one side of the processing area.

It can be understood that, since the storage component 31 stores a large number of trays, it occupies more space than the conveying component 32. The relative position of the storage component 31 in the transition device 30 corresponds to the relative position of the processing device in the processing device 20. Therefore, when the conveying component 32 is arranged in the first arrangement, the storage component 31 is located on one side of the conveying component 32 in a direction perpendicular to the direction in which the first conveyor conveys the trays. Since the first conveyor 321 is closer to the storage component 31 than the second conveyor 322, trays on the transfer path, after being conveyed by the first conveyor 321 into the processing device 20, are closer to the side of the processing device in the processing device 20, facilitating the processing of materials on the trays by the processing device.

In other embodiments, when the conveying component 32 is arranged in the second or third arrangement, the storage component 31 is located above the conveying component 32, making the structure of the transition device 30 more compact. Additionally, when the first conveyor 321 conveys trays to the processing device 20, the trays can be positioned below the processing device of the processing device 20, also facilitating the processing of materials by the processing device 20.

In some embodiments, as shown in FIG. 5, the number of transition mechanisms 324 is one, and the transition mechanism 324 is movable in a direction perpendicular to the direction in which the second conveyor conveys the trays, passing over the second conveyor 322.

In other embodiments, the transition mechanism 324 is movable in a direction perpendicular to the direction in which the first conveyor conveys the trays, passing over the first conveyor 321.

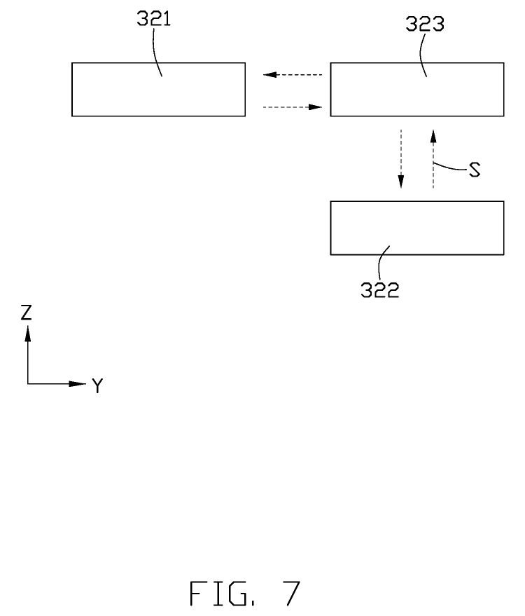

Furthermore, as shown in FIGS. 6 and 7, one transition mechanism 324 is movable in a direction perpendicular to the direction in which the first conveyor conveys the trays, passing over both the first conveyor 321 and the second conveyor 322, enabling one transition mechanism 324 to simultaneously handle functions related to both the first conveyor 321 and the second conveyor 322.

In other embodiments, the number of transition mechanisms 324 is two, and the number of supporting mechanisms 323 is also two. One transition mechanism 324 and one supporting mechanism 323 are associated with the first conveyor 321, while the other transition mechanism 324 and the other supporting mechanism 323 are associated with the second conveyor 322.

In some embodiments, the transition mechanism 324 includes a moving component (not shown in figures) and a first conveying unit (not shown in figures). The first conveying unit is used for carrying trays and moving them to convey trays outside the transition mechanism 324. The moving component is used for driving the first conveying unit to move the trays, enabling the transition mechanism 324 to transfer trays. The moving component is a power device, such as a cylinder, electric actuator, or screw module, capable of providing reciprocating force.

In some embodiments, the first conveyor 321, the second conveyor 322, and the first conveying unit are all conveyor belts.

In other embodiments, the first conveyor 321, the second conveyor 322, and the first conveying unit are all spaced conveyor rollers.

In some embodiments, the supporting mechanism 323 includes a second conveying unit (not shown in figures) located in the first area 3231 and the second area 3232. The structure of the second conveying unit is the same as that of the first conveying unit, enabling trays in the first area 3231 or the second area 3232 to be transferred to the first conveying unit.

In other embodiments, the transition mechanism 324 is a robotic arm device located on one side of the first conveyor 321, the second conveyor 322, and the supporting mechanism 323. The transition mechanism 324 is used for extending to the first conveyor 321, the second conveyor 322, and the supporting mechanism 323 to carry or release trays.

In some embodiments, as shown in FIGS. 5 and 6, both the first conveyor 321 and the second conveyor 322 include a third area 325 and a fourth area 326. Along the X direction and in the direction in which the first conveyor conveys trays, the third area 325 is located upstream of the fourth area 326.

In some embodiments, as shown in FIGS. 5 and 6, along the X direction, the transition mechanism 324 is located between the fourth area 326 and the third area 325. Both the third area 325 and the fourth area 326 are equipped with a conveyor belt (not labeled) or conveyor rollers. When a tray needs to be stored, as it is conveyed from the third area 325 to the fourth area 326 and passes the first conveying unit of the transition mechanism 324, the first conveying unit transfers the tray to the supporting mechanism 323. When a tray does not need to be stored, the first conveying unit of the transition mechanism 324, together with the conveyor belt or conveyor rollers of the third area 325 and the fourth area 326, conveys the tray out of the transition device 30. When the storage component 31 releases a tray, the first conveying unit of the transition mechanism 324 transfers the tray to the space between the third area 325 and the fourth area 326, and together with the conveyor belt or conveyor rollers of the fourth area 326, conveys the tray out of the transition device 30.

As shown in FIG. 6, when the supporting mechanism 323 extends along the X direction and the transition mechanism 324 is located between the fourth area 326 and the third area 325, in a direction perpendicular to the X direction, the first area 3231 corresponds to the third area 325 of the first conveyor 321, and the second area 3232 corresponds to the fourth area 326 of the first conveyor 321. This allows the storage component 31 to also be located between the third area 325 and the fourth area 326, enabling the transfer component 33, the first conveyor 321, the second conveyor 322, and the supporting mechanism 323 to be symmetrically distributed along the Y direction, resulting in a more rational and compact structural layout for the transition device 30. Alternatively, in other embodiments, the first area 3231 corresponds to the fourth area 326 of the first conveyor 321, and the second area 3232 corresponds to the third area 325 of the first conveyor 321.

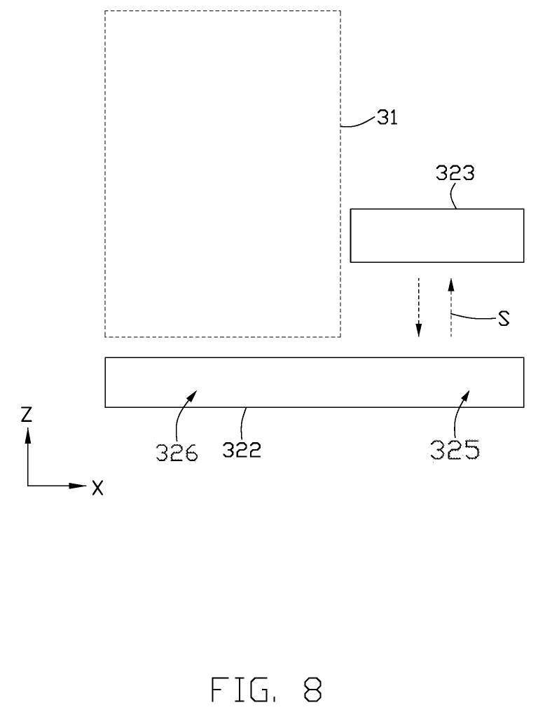

In other embodiments, as shown in FIG. 8, when the transition mechanism 324 passes over the third area 325 or the fourth area 326, the other area of the first conveyor 321 or the second conveyor 322 is equipped with a conveyor belt or conveyor rollers. Similarly, when a tray needs to be stored, as it is transferred from one processing device 20 through the transition device 30 to another processing device 20, the first conveying unit of the transition mechanism 324 transfers the tray to the supporting mechanism 323. When a tray does not need to be stored, the first conveying unit of the transition mechanism 324, together with the conveyor belt or conveyor rollers of the first conveyor 321 (or the second conveyor 322), conveys the tray out of the transition device 30. When the storage component 31 releases a tray, the first conveying unit of the transition mechanism 324 transfers the tray to the third area 325, and together with the conveyor belt or conveyor rollers of the first conveyor 321 (or the second conveyor 322), conveys the tray out of the transition device 30 (if the first conveying unit of the transition mechanism 324 is located in the fourth area 326, it directly conveys the tray outward).

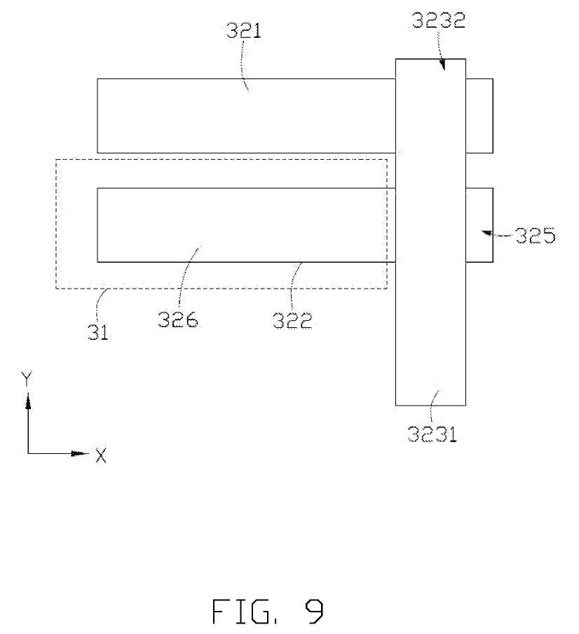

Furthermore, as shown in FIGS. 8 and 9, when the transition mechanism 324 passes over the third area 325 or the fourth area 326, the supporting mechanism 323 is located at the ends of the first conveyor 321 and the second conveyor 322 along the X direction. For example, in the Z direction, the supporting mechanism 323 aligns with the third area 325 of the second conveyor 322, extends along the Y direction, and the storage component 31 is distributed along the X direction with the supporting mechanism 323, located above the first conveyor 321 and the second conveyor 322, which also enhances the compactness of the transition device 30’s structural layout. During operation, the transition mechanism 324 transfers trays between the second conveyor 322 and the supporting mechanism 323 along the Z direction, and in this case, the storage component 31 is used for storing or releasing trays for the second conveyor 322.

As shown in FIG. 6, when the transition mechanism 324 is located between the fourth area 326 and the third area 325, the supporting mechanism 323 is distributed along the X direction. In a direction perpendicular to the X direction, the first area 3231 corresponds to the third area 325 of the first conveyor 321, and the second area 3232 corresponds to the fourth area 326 of the first conveyor 321, allowing the storage component 31 to be located between the third area 325 and the fourth area 326. This enables the transfer component 33, the first conveyor 321, the second conveyor 322, and the supporting mechanism 323 to be symmetrically distributed along the Y direction, further improving the rationality and compactness of the transition device 30’s structural layout. In this case, the first conveyor 321 and the second conveyor 322 of the conveying component 32 are arranged in the second or third arrangement, which, compared to the first arrangement, helps reduce the risk of interference between the supporting mechanism 323 and the first conveyor 321. Alternatively, in other embodiments, the first area 3231 corresponds to the fourth area 326 of the first conveyor 321, and the second area 3232 corresponds to the third area 325 of the first conveyor 321.

It can be understood that the first conveying unit, the first conveyor 321, and the second conveyor 322 all include conveyor rollers, with the conveyor rollers of the first conveying unit staggered relative to those of the first conveyor 321 or the second conveyor 322. This allows the conveyor rollers of the first conveying unit to move vertically through the conveyor rollers of the first conveyor 321 or the second conveyor 322, placing trays onto or lifting trays from the conveyor rollers of the first conveyor 321 or the second conveyor 322, while maintaining the conveying function of the first conveyor 321 or the second conveyor 322. It can also be understood that when the transition mechanism 324 is located on the third area 325 or the fourth area 326, both areas are equipped with conveyor rollers, meaning the transition mechanism 324 is located at one end of the first conveyor 321 or the second conveyor 322.

In some embodiments, as shown in FIG. 3, the transition device 30 includes a detector 34 located on the conveying component 32, used for detecting trays on the conveying component 32. For example, when the detector 34 detects a damaged tray, it sends a feedback signal to the transfer component 33, prompting the transfer component 33 to place the damaged tray in a designated area of the storage component 31 for storage, preventing the damaged tray from continuing into the production line 10 and causing risks of inaccurate material positioning.

In some embodiments, the detector 34 is used for detecting materials on the trays. When materials are damaged or defective, the detector 34 sends a feedback signal to all processing devices 20 and transition devices 30, causing the tray carrying the defective materials to be directly conveyed out of the production line 10, preventing further processing of the defective materials by the processing device 20. Meanwhile, the carrier car stores the defective materials in a designated area, improving the yield rate of materials.

In some embodiments, the detector 34 includes a linear laser scanner used for scanning trays on the conveying component 32 and sending feedback signals to the transfer component 33 to detect parameters such as the length, height, width, or flatness of trays or materials, achieving the effect of inspecting trays or materials.

In other embodiments, the detector 34 includes a CCD camera, which can also detect trays and materials through image recognition.

In some embodiments, the detector 34 can be located on the first conveyor 321, the second conveyor 322, or the transition mechanism 324, used for inspecting materials or trays during transfer, return, or storage/release by the storage component 31.

In some embodiments, the first conveyor 321, the second conveyor 322, the transition mechanism 324, or the supporting mechanism 323 are equipped with positioning mechanisms used for limiting tray movement and positioning trays accurately, improving the precision of tray carrying or releasing by the transition mechanism 324 or loading/unloading device.

In some embodiments, the materials are electronic products such as mobile phones.

In some embodiments, after the processing device 20 at the tail end 12 completes processing the materials, the processing device 20 is used for covering the trays with cover boards, the cover boards being used for protecting the materials loaded on the trays, reducing the risk of contamination from dust or other impurities falling onto the materials.

The embodiments shown and described above are only examples. Even though numerous characteristics and advantages of the present technology have been set forth in the foregoing description, together with details of the structure and function of the present disclosure, the disclosure is illustrative only, and changes may be made in the detail, including in matters of shape, size, and arrangement of the parts within the principles of the present disclosure, up to and including the full extent established by the broad general meaning of the terms used in the claims.

What is claimed is:

1. A transition device comprising:
a storage component configured for storing trays;
a conveying component comprising a first conveyor and a second conveyor, wherein the first conveyor is configured for conveying the trays loaded with materials, the second conveyor is configured for conveying the trays unloaded in opposite direction to the first conveyor; and
a transfer component configured for transferring the trays between the first conveyor and the storage component and transferring the trays between the second conveyor and the storage component.

2. The transition device of claim 1, wherein the conveying component further comprises a transition mechanism, and the transition mechanism is configured for providing the trays from the first conveyor to the transfer component and providing the trays from the second conveyor to the transfer component.

3. The transition device of claim 2, wherein the conveying component further comprises a supporting mechanism, the supporting mechanism is located on the second conveyor and on the first conveyor, the supporting mechanism comprises a first area and a second area, the transfer component further carries or releases the trays at the first area and the second area;
the transition mechanism is movable to a position between the first area and the second area, and the transition mechanism further carries or releases the trays at the first area or the second area.

4. The transition device of claim 3, wherein the first area and the second area are arranged in a direction parallel or perpendicular to a direction in which the first conveyor conveys the trays;
the storage component is located between the first area and the second area, and in the direction of the arrangement of the first area and the second area, both sides of the storage component define openings, the openings are configured for the trays to pass through;
the transfer component is configured for transferring the trays between the storage component and the first area and transferring the trays between the storage component and the second area.

5. The transition device of claim 2, wherein the transition mechanism is movable in a direction perpendicular to the direction in which the first conveyor conveys the trays, for carrying the trays from the first conveyor or releasing the trays onto the first conveyor;
and the transition mechanism is movable in a direction perpendicular to the direction in which the second conveyor conveys the trays, for carrying the trays from the second conveyor or releasing the trays onto the second conveyor.

6. The transition device of claim 1 further comprises a detector configured for detecting the trays on the conveying component and sending feedback signals to the transfer component.

7. The transition device of claim 6, wherein the detector is a linear laser scanner configured for scanning the trays on the conveying component and sending feedback signals to the transfer component.

8. The transition device of claim 1, wherein storage component is arranged on a side of the conveying component in a direction perpendicular to the direction in which the first conveyor conveys the trays.

9. The transition device of claim 4, wherein the storage component defines a plurality of compartments for storing the trays, both sides of each of the plurality of compartments define the openings, the transfer component comprises a robot arm and a feeding mechanism, the robot arm is configured for carrying the trays from the first area or the second area to the feeding mechanism, the feeding mechanism is movable into each of the plurality of compartments through a corresponding opening of the openings to store the trays in each of the plurality of compartments.

10. A production line comprising:
at least two processing devices arranged from a head end to a tail end of the production line, and each of the at least two processing devices configured for processing materials on trays;
at least one transition device, each of the at least one transition device comprising:
a storage component configured for storing the trays;
a conveying component comprising a first conveyor and a second conveyor, wherein the first conveyor is configured for conveying the trays loaded with the materials, the second conveyor is configured for conveying the trays unloaded in opposite direction to the first conveyor; and
a transfer component configured for transferring the trays between the first conveyor and the storage component and transferring the trays between the second conveyor and the storage component, wherein one of the at least one transition device is located between each two adjacent ones of the at least two processing devices, each transition device is configured for transferring and storing the trays between the corresponding two adjacent processing devices.

11. The production line of claim 10, wherein the conveying component further comprises a transition mechanism, and the transition mechanism is configured for providing the trays from the first conveyor to the transfer component and providing the trays from the second conveyor to the transfer component.

12. The production line of claim 11, wherein the conveying component further comprises a supporting mechanism, the supporting mechanism is located on the second conveyor and on the first conveyor, the supporting mechanism comprises a first area and a second area, the transfer component further carries or releases the trays at the first area and the second area;
the transition mechanism is movable to a position between the first area and the second area, and the transition mechanism further carries or releases the trays at the first area or the second area.

13. The production line of claim 12, wherein the first area and the second area are arranged in a direction parallel or perpendicular to a direction in which the first conveyor conveys the trays;
the storage component is located between the first area and the second area, and in the direction of the arrangement of the first area and the second area, both sides of the storage component define openings, the openings are configured for the trays to pass through;
the transfer component is configured for transferring the trays between the storage component and the first area and transferring the trays between the storage component and the second area.

14. The production line of claim 11, wherein the transition mechanism is movable in a direction perpendicular to the direction in which the first conveyor conveys the trays, for carrying the trays from the first conveyor or releasing the trays onto the first conveyor;
and the transition mechanism is movable in a direction perpendicular to the direction in which the second conveyor conveys the trays, for carrying the trays from the second conveyor or releasing the trays onto the second conveyor.

15. The production line of claim 10, wherein the transition device further comprises a detector configured for detecting the trays on the conveying component and sending feedback signals to the transfer component.

16. The production line of claim 15, wherein the detector is a linear laser scanner configured for scanning the trays on the conveying component and sending feedback signals to the transfer component.

17. The production line of claim 10, wherein storage component is arranged on a side of the conveying component in a direction perpendicular to the direction in which the first conveyor conveys the trays.

18. The production line of claim 13, wherein the storage component defines a plurality of compartments for storing the trays, both sides of each of the plurality of compartments define the openings, the transfer component comprises a robot arm and a feeding mechanism, the robot arm is configured for carrying the trays from the first area or the second area to the feeding mechanism, the feeding mechanism is movable into each of the plurality of compartments through a corresponding opening of the openings to store the trays in each of the plurality of compartments.

19. The production line of claim 10, wherein one of the at least one transition device is located after the processing device at the tail end for transferring the trays loaded with materials to a carrier car; and
one of the at least one transition device is located before the processing device at the head end for transferring the trays loaded with materials from a carrier car to the processing device at the head end.

20. The production line of claim 10, wherein the processing device at the tail end covers the trays with cover boards after finishing process, the cover boards are configured for protecting the materials loaded on the trays.
